(19) United States
(12) Patent Application Publication
(10) Pub. No.: US 2023/0152946 A1
(43) Pub. Date: May 18, 2023

(54) METHODS AND APPARATUS FOR SEARCH OF AN AREA RENDERED WITHIN A BROWSER

(71) Applicant: GOOGLE LLC, Mountain View, CA (US)

(72) Inventors: Yana Yushkina, Seattle, WA (US); Benjamin Goldberger, Los Angeles, CA (US); Peter Boström, Seattle, WA (US); Jason Edward Dishlip, Seattle, WA (US); Nicholas Sexton, Brooklyn, NY (US); Mark Chang, Seattle, WA (US); John Oliver Por, San Francisco, CA (US); Carlos Marin Capriles, Venice, CA (US); Hyun Ji Bae, Marina Del Rey, CA (US); Greg Schechter, Los Angeles, CA (US); Allison Stanfield, Beaverton, OR (US); Timothy Parsons, Santa Monica, CA (US); David Wu, Forest Hills, NY (US); Juan Mojica, Alhambra, CA (US); Tina Lin Zeng, Montebello, CA (US); Callum Lamb, Berkeley, CA (US); Joseph Engel, Menlo Park, CA (US); Samantha Chen, San Mateo, CA (US); Thomas Lukaszewicz, Mountain View, CA (US); Frank Goodman, San Francisco, CA (US)

(21) Appl. No.: 18/056,045

(22) Filed: Nov. 16, 2022

Related U.S. Application Data
(60) Provisional application No. 63/264,213, filed on Nov. 17, 2021.
(60) Provisional application No. 63/266,296, filed on Dec. 31, 2021.

(51) Int. Cl. G06F 3/0483; G06F 3/04842; G06F 16/532

(52) U.S. Cl. CPC G06F 3/0483; G06F 3/04842; G06F 16/532

(57) ABSTRACT

In one general aspect, a method can include causing display of a webpage within a display area of a browser, and causing display of a search area indicator associated with an area of the webpage. The method can include receiving a selection of the search area indicator. In response to the selection of the search area indicator being received the method can include defining an image corresponding to the area, and triggering a search query based on the image. The method can include receiving a search result in response to the search query, and causing display of the search result in a search result area outside of the display area where the search result area is within the browser.

### RELATED APPLICATIONS

This application claims priority to and the benefit of U.S. Provisional Application No. 63/264,213 filed on Nov. 17, 2021, and claims priority to and the benefit of U.S. Provisional Application No. 63/266,296 filed on Dec. 31, 2021, both of which are incorporated herein by reference in their entireties.

### BACKGROUND

A web browser can be used to display content that is searched via a search engine. Content can be displayed within the web browser in response to selection of one or more of the search results by a user.

### SUMMARY

The disclosure is related to searching of content displayed in a webpage through a capture of at least a portion of the webpage content. Specifically, an area of the webpage can be selected (e.g., selected using a gesture and/or an input device) and the selected region can be searched in response to the selection of the region. The search results can be displayed within a search result area of the browser, or in a search result area of another browser, so that the content of the webpage is maintained (e.g., persists) in the browser while the search results are displayed. At least one of the search results can be selected, and content associated with selected search result can be displayed. In some implementations, the content associated with the search results can replace content of the webpage within the browser. In some implementations, the content associated with the search results can be displayed within another browser. The search results can continue to be displayed (e.g., can be maintained, or can persist) even as the content of the search results are navigated and/or displayed.

In one general aspect, a method can include causing display of a webpage within a display area of a browser, and causing display of a search area indicator associated with an area of the webpage. The method can include receiving a selection of the search area indicator. In response to the selection of the search area indicator being received the method can include defining an image corresponding to the area, and triggering a search query based on the image. The method can include receiving a search result in response to the search query, and causing display of the search result in a search result area outside of the display area where the search result area is within the browser.

### BRIEF DESCRIPTION OF THE DRAWINGS

FIGS. 1A and 1B are diagrams that illustrate search of content displayed in a webpage through capture of a selection of an area of at least a portion of the content within the webpage.

FIG. 1C illustrates content of a webpage rendered in a navigation area within the tab of the browser shown in FIG. 1A.

FIG. 2 illustrates content of a webpage rendered in a navigation area within a tab of a browser.

FIG. 3 illustrates a search result area and a navigation area rendered within a tab of a browser.

FIGS. 4A and 4B illustrate search result areas, navigation areas, and display areas rendered within tabs of a browser.

FIG. 5 illustrates a security feature associated with the implementations described herein.

FIGS. 6A and 6B illustrate a search query triggered based on a selection of an area that spans multiple elements within a webpage.

FIG. 7 illustrates a computing system and search server for implementing the concepts described herein.

FIG. 8 is a flowchart that illustrates a method of performing at least some of the concepts described herein.

FIG. 9 illustrates an implementation where history related to search queries are shared between devices.

FIG. 10 is a diagram that illustrates indicators of areas that can be selected for a search query.

FIGS. 11A and 11B illustrate activation of a search input area that can be used to trigger search area indicators.

FIG. 12 shows an example of a generic computer device and a generic mobile computer device, which may be used with the techniques described herein.

### DETAILED DESCRIPTION

The disclosure is related to searching of content displayed in a webpage through a capture of at least a portion of the webpage content. Specifically, an area of the webpage can be selected (e.g., selected using a gesture and/or an input device) and the selected region can be searched in response to the selection of the region. The search results can be displayed within a search result area of the browser, or in a search result area of another browser, so that the content of the webpage is maintained (e.g., persists) in the browser while the search results are displayed. At least one of the search results can be selected, and content associated with selected search result can be displayed. In some implementations, the content associated with the search results can replace content of the webpage within the browser. In some implementations, the content associated with the search results can be displayed within another browser. The search results can continue to be displayed (e.g., can be maintained, or can persist) even as the content of the search results are navigated and/or displayed. The browser can be referred to as a browser window when associated with a window of an operating system (OS).

A technical problem associated with content in a webpage is that the content may not be readily selected and/or may not be immediately processed for searching. The content within the webpage can be consumed by a user and/or links within the webpage can be accessed, but the content itself may not be readily searched using a search engine. For example, text within the webpage can be copied and pasted into a search engine, but this process may require multiple manual steps, time, storage resources, and/or so forth.

Another technical problem associated with content in a webpage, is that even after content to be searched within the webpage is identified, the content within the webpage may not be maintained during a search unless a separate browser, tab, or application is used. For example, content within a webpage can be copied for searching, and the webpage can be replaced with a search engine interface or a separate browser or tab can be used to search the content.

At least one technical solution to the technical problems described above is that an area of a webpage within a browser can be selected. Also, the selected region can be searched in response to the selection of the region (e.g., with little or no manual intervention). The search results can be displayed within a search result area of the browser so that the content of the webpage is maintained (e.g., persists) in the browser in a separate display area while the search results are displayed.

At least one technical effect of this technical solution is that the original webpage content is not lost while the search results are consumed by a user. Search results within a search result area and webpage content within a display area can be simultaneously displayed within the browser (e.g., within a tab of the browser). Accordingly, the proposed solution allows for making search results available to a user in a separate area of the browser so that the user may interact with the search result, e.g., for having content presented associated with the search results, while at the same time still and simultaneously allowing interaction of the user with the webpage and in particular the selected region which was used for triggering the search query.

In some implementations, a search result area can be integrated as part of the browser so that the search result area may not be spoofed (e.g., imitated) by a third party or the owner of the webpage content. This can be implemented as a security feature so that a user can distinguish legitimate (e.g., authentic) search results provided by a search query from search results that may not be legitimate can be inserted by a third party or by the provider of the webpage. Accordingly, the technical problem of spoofing search results can be obviated by the technical solution of integrating a search result area within the browser as described above. The technical effect of integration of a search result area within a browser is that spoofing can be prevented.

As mentioned above, in some implementations, search results can continue to be displayed (e.g., can be maintained, or can persist) in a search result area even as the content of the search results are navigated and/or displayed. The content associated with the search results can be displayed within a navigation area simultaneously within the browser (e.g., within a tab of the browser) with the search result area. Accordingly, the technical problem of being unable to simultaneously navigate content associated with search results while viewing the search results in a search result area is solved by the technical solution and technical effect described above.

The browsers described herein can be executed within a computing device. For example, the browsers can be executed within a laptop device. In some implementations, the browsers can be executed within a mobile device.

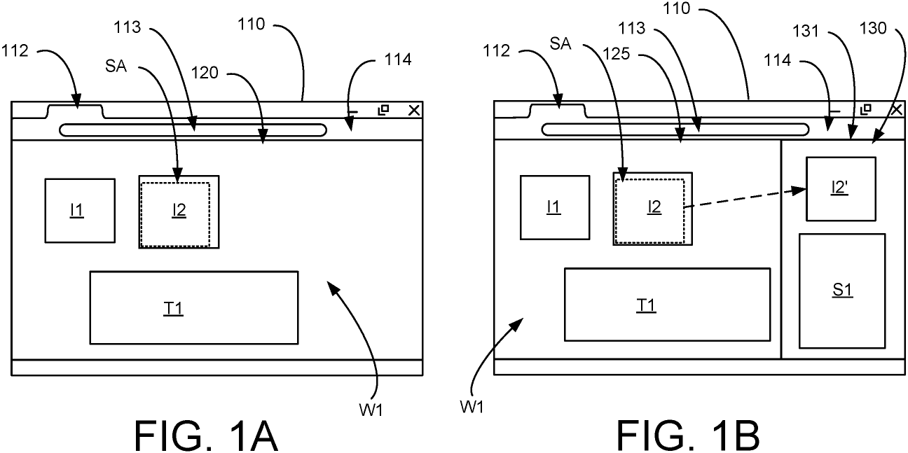

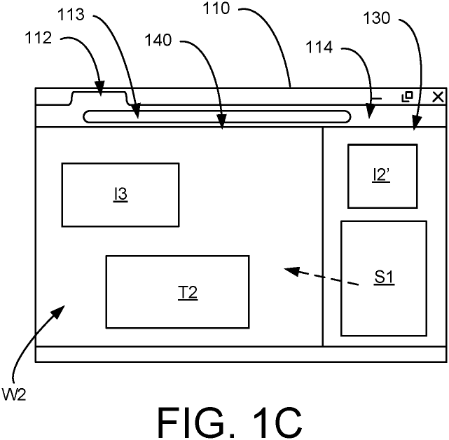

FIGS. 1A and 1B are diagrams that illustrate search of content I2 displayed in a webpage W1 through capture of a selection of an area SA of at least a portion of the content I2 within the webpage W1. The webpage W1 is displayed (e.g., rendered) within a display area 120 within a tab 112 of a browser 110. In response to the selection (illustrated with dashed lines) of the area SA of the webpage W1, a search query is triggered of the portion of the content I2. Accordingly, the search query is triggered without, or with very little manual intervention from a user. Specifically, in response to the selection of the area SA of the webpage W1 being completed, the search query is triggered without manual intervention. Additional steps (e.g., saving information, entering a search query, interacting with a user interface such as another browser to launch a search) to trigger the search query are eliminated.

For example, a user can select the area SA using an input device such as a mouse or touchpad (e.g., not shown), a search query is triggered of the portion of the content I2. Accordingly, the search query is triggered without, or with very little manual intervention from a user other than selection of the area SA. Additional input other than the selection may not be needed to trigger the search query.

In response to the search query being completed, search results S1 are rendered within a search result area 130 of the tab 112 of the browser 110 as shown in FIG. 1B. A copy I2′ of the portion of the content I2 is illustrated in the search result area 130. The correspondence between the area I2 and the copy I2′ is illustrated with a dashed arrow. In some implementations, the copy I2′ of the portion of the content I2 is not shown in the search result area 130. In some implementations, the copy I2′ of the portion of the content I2 is scaled to a different size (e.g., smaller size) than the original area SA.

The search results S1 can be rendered within the search result area 130 in response to the search query being triggered without, or with very little manual intervention from a user (other than selection of the search area SA). In some implementations, in response to the selection of the area SA of the webpage W1 being completed, the search query and rendering of the search results S1 within the search result area 130 are triggered without manual intervention. Additional steps (e.g., saving information, entering a search query, interacting with a user interface such as another browser to launch a search) to trigger the search query and rendering of the search results S1 within the search result area 130 can be eliminated.

The search results S1 can be search results (e.g., rank-ordered search results) that include, and/or are linked, to content associated with the area SA (e.g., the copy I2′ of the area SA). In some implementations, the search results S1 can include text or can be represented by text. In some implementations, the search results S1 can include images. In some implementations, the search results S1 can include images associated with text. In some implementations, the search results S1 can include links to content (e.g., images, webpages, etc.) associated with the area SA. In some implementations, the search results S1 can be prioritized so that the most relevant search results (or a subset thereof) are rendered within the search result area 130. In some implementations, the search results S1 can be prioritized so that the most relevant search results (or a subset thereof) are rendered toward a top of the search result area 130.

In some implementations, the search of the area SA can be an image search. The area SA that is selected can be captured as an image (e.g., a collection of pixels associated with or representing the image). Accordingly, a search engine (not shown) at, for example, a search server (not shown) can receive the captured image of the area SA and can conduct a search based on the captured image. A search query by the search engine can include, or can be based on, the captured image. In some implementations, the captured image can be, for example, an image in a bitmap format. In some implementations, the captured image can be, for example, a screen capture of the area SA.

The search of area SA can be a search used to identify various objects such as landmarks, products, wildlife, logos, brands, and/or so forth. The search of area SA can be a search used to identify objects similar to those captured in the area SA. In some implementations, text can be identified and/or searched from the area SA. In some implementations, text in the area SA can be translated into another language. In some implementations, the text represented in a language different from the original language of the original text.

As shown in at least FIG. 1A, content I1, I2, and T1 are rendered within the webpage W1. In some implementations, the content I1, I2 and/or T1 can be images, text, and/or so forth rendered within the webpage W1. The content I1, I2, and/or T1 can be provided by the provider of the webpage W1 or provided by another provider into the webpage W1.

In some implementations, a search query by the search engine can include, or can be based on, a captured image of a dynamic element (e.g., a video, a moving series of elements, an object in motion) being rendered with the webpage W1. Accordingly, a search can be conducted on a portion of (e.g., a screen capture of) a video or other dynamic element being rendered within, for example, the webpage W1.

In some implementations, the selection of the area SA can be performed in response to an input device (not shown). For example, the selection of the area SA can be triggered in response to an input device such as a touchpad device, a keyboard, a mouse input device, controller, and/or so forth. In some implementations, the selection of the area SA can be performed in response to a gesture (e.g., a gesture triggered via touchpad device, a hand gesture, a gesture performed using an input device, etc.).

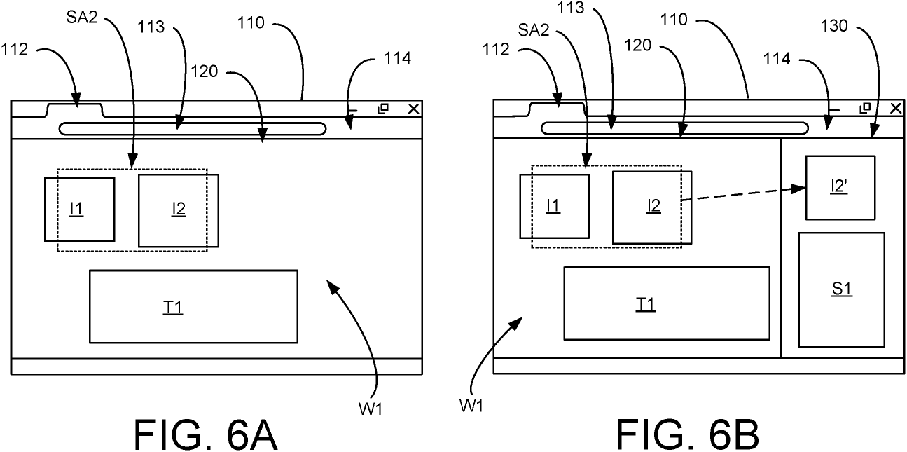

In this implementation, the area SA does not correspond exactly with an area of the content I2. In some implementations, the area SA can be smaller than the area of the content I2. In some implementations, the area SA can be larger than the area of the content I2. More details regarding selection of areas across multiple elements is described in connection with at least FIGS. 6A and 6B.

As shown in FIGS. 1A and 1B, the browser includes an address bar area 114. An address of the webpage W1 can be illustrated in the address bar area 114 (e.g., input address area 113). Other controls, icons, and/or so forth can be included in the address bar area 114. The address bar area 114 can be controlled by and/or associated with the browser 110 (e.g., the browser application). The address bar area 114 can be controlled by the browser 110 instead of the webpage W1 and/or a provider of the webpage W1.

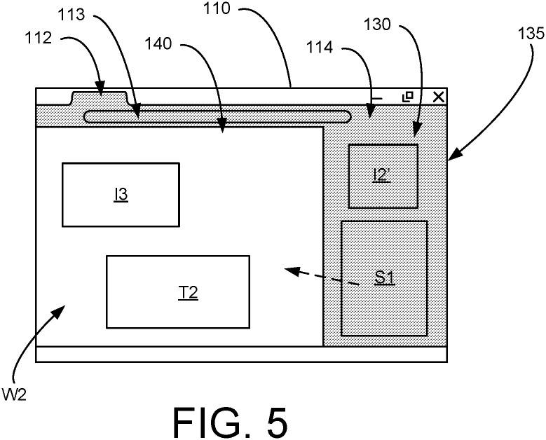

As shown in FIG. 1B, the search result area 130 is separated from the address bar area 114 by a line 131. In some implementations, the line 131 can be eliminated (e.g., omitted), in any of the implementations described herein, for security purposes. This is a line that a third party (e.g., provider of the webpage W1) may not remove (e.g., paint over, scrub out). This is a line that is controlled (e.g., provided by, eliminated by) the provider of the browser 110 (e.g., browser application). More details regarding this security feature are described below in connection with at least FIG. 5.

As shown in FIG. 1B, in response to the search result area 130 being rendered in response to the search query, the size (e.g., an area) of the display area 120 is decreased to a size of the display area 125. In other words, the display area 120 is resized (e.g., decreased in size) in response to the search result area 130 being displayed. The webpage W1 can be modified (e.g., scaled) in layout to fit (e.g., fit for display) into the display area 125. In some implementations, the display area 120 shown in FIG. 1A can be divided into the display area 125 and the search result area 130 as shown in FIG. 1B. The combined areas of the display area 125 and the search result area 130 as shown in FIG. 1B can be the same as the area of the display area 120 (e.g., original display area of the browser 110) shown in FIG. 1A. In some implementations, the combined areas of the display area 125 and the search result area 130 can be different from (e.g., smaller than, larger than) the area of the display area 120. The display area 120 is resized to display area 125 such that the search area 130 is disposed within an area allocated, prior to the receiving the selection of the area (e.g., search area S1), to the display area 120 (e.g., entire display area 120).

Although not shown in FIG. 1B, the location of the search result area 130 can be different than shown in FIG. 1B. For example, the search result area 130 can be smaller in size. In some implementations, the search result area 130 can be included along a different side of the browser 110 (e.g., along a bottom portion, along a top portion, along the left side, and/or so forth). In some implementations, the search result area 130 can float above (e.g., can be rendered in a window above, can be rendered in a window above that moves independent of the browser 110) the display area 120 so that the display area 120 in FIG. 1A is not decreased in size to the area of the display area 125 shown in FIG. 1B. In some implementations, the search result area 130 can be a different shape (e.g., a circular shape) rather than a square or rectangular shape.

In some implementations, after the search result area 130 has been rendered with the search results S1 as shown in at least FIG. 1B, an additional search query can be triggered using the search result area 130. For example, a search result within the search result area 130 can be selected and used to trigger a rendering of one or more images and/or text associated with the search result selected from the search result area 130.

In some implementations, after the search result area 130 has been rendered with the search results S1 as shown in at least FIG. 1B, an additional search query can be triggered using the browser 110 (e.g., the display area 125). In some implementations, the additional search query can include selection of an additional area within the display area 125 of the webpage W1 other than the search area SA. In some implementations, the additional search query can be a text-based search query that modifies (e.g., further refines, filters) the search results S1 in the search result area 130. The additional search query can be an image-based search query that modifies (e.g., further refines, filters) the search results S1 in the search result area 130. In other words, the additional search query can modify the search results S1 to further prioritize the search results S1, filter the search results S1, and/or so forth.

In some implementations, although not shown, the search results S1 can be bookmarked or associated with a bookmark of the browser 110. In some implementations, each of the search results can be bookmarked or associated with a bookmark of the browser 110. In some implementations only a finite number of (or only a portion of) the search results (e.g., top 5) may be bookmarked.

In some implementations, although not shown, the search results S1 (or a prioritized subset thereof) can be associated with a tab group (e.g., a set of tabs within the browser 110 that are related manually, based on content, and/or so forth). For example, a first search result from the search results S1 can be associated with a first tab (not shown), and a second search result although not shown, can be associated with a second tab (not shown). The first search result and the second search result can be associated with a tab group (e.g., a group of tags that are associated with a single name). In some implementations only a finite number of the search results (e.g., top 5) may be associated with a tab and/or associated with a tab group.

Further to the implementation shown in FIGS. 1A and 1B, in some implementations, a new web address (in place of a web address for the webpage W1) can be input into input address area 113 of the address bar area 114 after the search result area 130 is defined. In response to the new web address area, a different webpage (not shown) (or other content) can replace the webpage W1 in the display area 125, while maintaining the search results S1 in the search result area 130. In other words, the search results S1 can be maintained even while navigating within the display area 125 using the address bar area 114 of the browser 110.

In some implementations, a user interface element (e.g., a back button, a back arrow) can be used to remove (e.g., clear, navigate away from) the search results S1 in the search result area 130. In some implementations, the user interface element can be used to remove (e.g., clear) the search results S1 and/or the search result area 130. In some implementations, the user interface element can be used to navigate away from (e.g., backward from) the webpage W1, the search results S1 and/or the search result area 130.

FIG. 1C illustrates content of a webpage W2 rendered in a navigation area 140 within the tab 112 of the browser 110 shown in FIG. 1A. The content of the webpage W2 is rendered in the navigation area 140 in response to an interaction (e.g., a user interaction) with the search results S1 in the search result area 130. The navigation area 140, in this implementation, replaces (e.g., changes) the display area 125. The webpage W2 displayed in the navigation area 140, in this implementation, replaces the webpage W1 displayed in the display area 125.

The navigation area 140 can be used to consume (e.g., explore) the search results S1 in the search result area 130. For example, in response to a first search result being selected from the search results S1, first content can be rendered in the navigation area 140. In response to a second search result being selected from the search results S1, second content can be rendered in the navigation area 140 instead of, or in addition to, the first content. The content can be navigated while the search results S1 are maintained within the search result area 130.

Further to the implementation shown in FIG. 1C, in some implementations, a new web address can be input into input address area 113 of the address bar area 114 after the search result area 130 and the navigation area 140 are defined. In response to the new web address area, a different webpage (not shown) can replace the webpage W2 (or other content) in the navigation area 140, while maintaining the search results S1 in the search result area 130. In other words, the search results S1 can be maintained even while navigating within the navigation area 140 using the address bar area 114 of the browser 110.

In some implementations, a user interface element (e.g., a back button, a back arrow) can be used to remove (e.g., clear, navigate away from) content rendered in the navigation area 140 (e.g., the webpage W2). In some implementations, the user interface element can be used to remove (e.g., clear) the search results S1, search result area 130, and/or the navigation area 140. In some implementations, the user interface element can be used to navigate away from (e.g., backward from) the webpage W2, the search results S1 and/or the search result area 130.

Although discussed in the context of a webpage W2, in some implementations, the content rendered in the navigation area 140 may not be a webpage. In some implementations, the content displayed in the navigation area 140 may not be a webpage and/or may not be associated with a webpage. In some implementations, the content displayed in the navigation area 140 can be in an image, a link, a video, text, and/or so forth.

In some implementations, an interaction can include a selection. In some implementations, an interaction and/or selection (or an indication thereof) can be used to trigger an action or result.

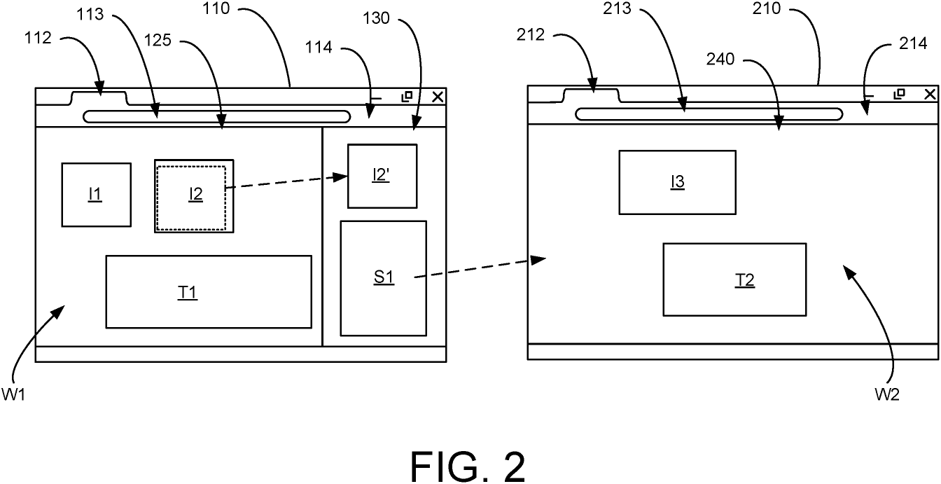

FIG. 2 illustrates content of a webpage W2 rendered in a navigation area 240 within a tab 212 of a browser 210 (e.g., browser window) separate from the browser 110 (e.g., browser window). FIG. 2 is a variation of the implementations described in connection with FIGS. 1A through 1C. Accordingly, the description of FIGS. 1A through 1C and the variations described therein, can be applied to FIG. 2. Specifically, FIG. 1C corresponds with the browser 110 state shown in the left of FIG. 2.

In this implementation, the content of the webpage W2 is rendered in the navigation area 240 of the browser 210 (which is a separate browser from browser 110 and can be referred to as an additional browser) in response to an interaction (e.g., a user interaction) with the search results S1 in the search result area 130 of the browser 110. This is in contrast to FIG. 1C where the webpage W2 is rendered within the browser 110 (e.g., within the same browser). The navigation area 240 of the browser 210 does not replace the display area 125 of the browser 110 (as shown in FIG. 1C) and instead is opened in the browser 210. Accordingly, the content of the webpage W1 can be maintained within the display area 125 in the browser 110 alongside the search result area 130.

Also, in response to the webpage W2 (or other content) being rendered in the navigation area 240 of the browser 210, the search results S1 in the search result area 130 are maintained in browser 110. In other words, the search results S1 can be maintained even while navigating within the navigation area 240 of the browser 210.

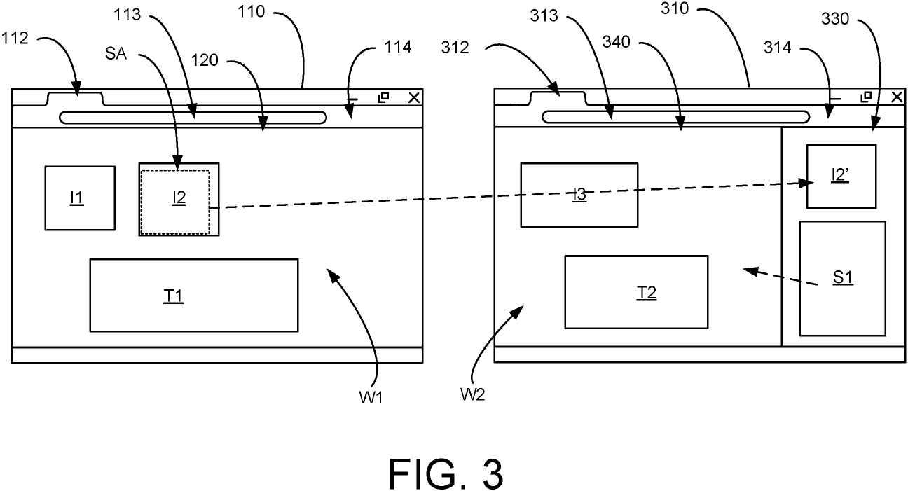

FIG. 3 illustrates a search result area 330 and a navigation area 340 rendered within a tab 312 of a browser 310 (e.g., browser window) separate from the browser 110 (e.g., browser window). In response to the search query being completed, search results S1 are rendered within a search result area 330 of the tab 312 of the browser 310 as shown in FIG. 3. A copy I2′ of the portion of the content I2 is illustrated in the search result area 330. Accordingly, the search result area 330 of the browser 310 does not replace (or reduce the area of) the display area 120 of the browser 110 (including webpage W1).

The search results S1 within the search result area 330 can be navigated within the navigation area 340 in substantially the same way as described above in connection with at least FIG. 1B. Accordingly, the search result area 330 and the navigation area 340 of the browser 310 do not replace (or reduce the area of) the display area 120 of the browser 110 (including webpage W1). Accordingly, the content of the webpage W1 can be maintained within the display area 120 in the browser 110 without a search result area.

As shown in FIG. 3, the search result area 330 is generated within a new browser-browser 310. The search results S1 in the search result area 330 can be maintained in browser 310. The search results S1 can be maintained within the search result area 330 within the browser 310 even while navigating within the navigation area 340 of the browser 310. Accordingly, the original webpage W1 can be maintained within browser 110, while further navigation can occur in browser 310 while also maintaining the search result area 330 in browser 310.

In some implementations, a browser window where search results are rendered can be referred to as a search result browser window. In this case, the browser 310 can be the search result browser window. In some implementations, a browser window where navigation occurs can be referred to as a navigation browser window. In this case, the browser 310 can be the navigation browser window. In some implementations, a browser window including the original webpage W1 can be referred to as a main browser window. In this case, the browser 110 can be the main browser window. Accordingly, as shown in FIG. 3, the browser 310 can be the search result browser window and the navigation browser window, and the browser 110 can be the main browser window.

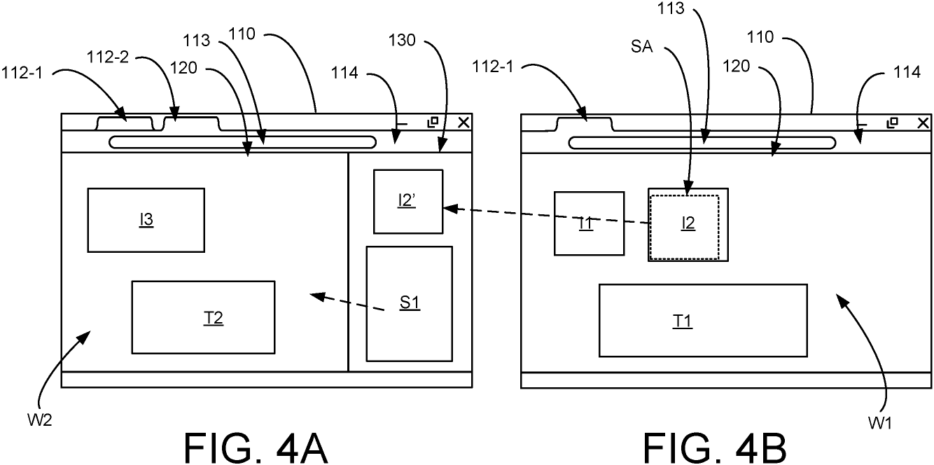

FIG. 4A illustrates the search result area 130 and the navigation area 140 rendered within a tab 112-2 of the browser 110 separate from a tab 112-1 (not shown in FIG. 4A) where the display area 120 is rendered. Content of the tab 112-1 (e.g., existing tab, main tab) is shown in FIG. 4B. FIG. 4B illustrates the display area 120 similar to what is shown in at least FIG. 1A.

In response to a search query being completed, search results S1 are rendered within a search result area 130 of the tab 112-2 (e.g., a new tab, auxiliary tab) of the browser 110 as shown in FIG. 4A. A copy I2′ of the portion of the content I2 is illustrated in the search result area 130. Accordingly, the search result area 130 of the tab 112-2 of the browser 110 does not replace (or reduce the area of) the display area 120 of the tab 112-1 of the browser 110 (including webpage W1).

The search results S1 within the search result area 130 of the tab 112-2 of the browser 110 can be navigated within the navigation area 140 in substantially the same way as described above in connection with at least FIG. 1B. Accordingly, the search result area 130 and the navigation area 140 of the tab 112-2 of the browser 110 do not replace (or reduce the area of) the display area 120 of the tab 112-1 of the browser 110 (including webpage W1). Accordingly, the content of the webpage W1 can be maintained within the display area 120 in the tab 112-1 of the browser 110 without a search result area.

In some implementations, navigation of search results S1 can be rendered within an existing tab (rather than a new tab). Content in the existing tab can be replaced in some implementations. In some implementations, a new tab can be opened for navigation of each search result from the search results S2 being selected.

In some implementations, a tab where search results are rendered can be referred to as a search result tab (e.g., as shown in FIG. 4A). In some implementations, a tab where navigation occurs can be referred to as a navigation tab.

FIG. 5 illustrates a security feature associated with the implementations described herein. As shown in FIG. 5, the address bar area 114 of the browser 110 and the search result area 130 are merged into one contiguous area (e.g., continuous area). This contiguous area (e.g., combined address bar area 114 and search result area 130) can be referred to as a browser search area 135. This is illustrated by the gray color that is contiguous between the address bar area 114 and the search result area 130. This implementation shown and described in connection with FIG. 5 can be combined with any of the implementations described above, for example, in connection with FIGS. 1A through 4B (and other figures below (e.g., FIG. 6B)). Specifically, as an example, FIG. 5 can be a transition from FIG. 1A, and the browser search area 135 can be implemented in FIGS. 1B and 1C. Similarly, the browser search area 135 can be implemented in at least FIGS. 2, 3, 4A, 6B, 9, 11A, 11B, and so forth.

The search result area 130 can be integrated as part of the browser 110 (e.g., address bar area 114) as the browser search area 135 so that the search result area 130 may not be spoofed (e.g., imitated) by, for example, a third party or the owner of the content of the webpage W1 (not shown) and/or the webpage W2 content. Because the search result area 130 is part of the application of the browser 110, the integration of the search result area 130 would be difficult to imitate. No clear separation (e.g., no separate line (e.g., line 131 shown in FIG. 1B is eliminated)) exists between the search result area 130 and the address bar area 114. Any background or theme applied to the address bar area 114 would flow into (and would be contiguous with) the search result area 130 (as illustrated by the gray area). The contiguous background would be difficult for a third party (e.g., provider of the webpage W1) to imitate within an application of the browser 110. Moreover, the browser search area 135 can be implemented as a security feature so that a user can distinguish legitimate search results provided by a search query from search results that can be inserted by a third party or by the provider of the webpage.

A contiguous background across the entirety of the browser search area 135 (including the search result area 130) can be an indicator of control of the entire browser search area 135 by the browser 110. If the entire browser search area 135 were not contiguous (e.g., if there were breaks or discontinuities in the background theme, image, and/or so forth), this would be an indication that the entirety of the browser search area 135 and/or the content included therein, were not controlled by the browser 110 and/or may not be authentic.

Described another way, the content that is rendered in the navigation area 140 can be attributed to (e.g., controlled by, produced by) content producer of the webpage W2 (after navigation to the webpage W2 is triggered via the search results S1). The content rendered within the browser search area 135 can be attributed to (e.g., controlled by, produced by) the browser 110. The content in the webpage W2 can be independently controlled by the content owner of the webpage W2 and separate from the browser 110. The content within the browser search area 135 (and specifically the search results S1) can be independently controlled by (and produced by) the browser 110 and separate from the webpage W2. A content producer of the webpage W2 may not produce or modify the search results S1.

The combining of the search result area 130 and the address bar area 114 can be an indicator of the authenticity of the content in the search result area 130. When the search result area 130 and the address bar area 114 are combined, it signifies that the browser 110 (or provider of the browser 110) is providing the search results S1 in the search result area 130. When a separating line is present (e.g., line 131 shown in FIG. 1B), results in the area of the search result area 130 may be provided by an untrusted provider (e.g., a third party).

In FIG. 5, the navigation area 140 is shown as being adjacent to the browser search area 135 (or a portion thereof). In some implementations, the display area 125 (as shown in FIG. 1B, for example) can be included in the browser 110 adjacent to the browser search area 135 (or a portion thereof).

FIGS. 6A and 6B illustrate a search query triggered based on a selection of an area SA2 that spans multiple elements (e.g., at least two elements or images) within the webpage W1. The concepts associated with FIGS. 6A and 6B can be combined with any of the features described above in connection with FIGS. 1A through 5 (or any of the figures described after FIGS. 6A and 6B).

In this example implementation, the selection area SA2 spans at least portions of the images I1 and I2. Accordingly, an image capture associated with the selection area SA2 includes portions of the images I1 and I2 as well as portions of the webpage W1 around the images I1 and I2. The image capture of the area SA2 can be used to trigger a search query as described above, and can result in search results S1 (which can be persistent as described above).

Because the area SA2 spans multiple areas of interest (e.g., images, text areas), disambiguation may be needed before triggering (e.g., conducting) a search. For example, a search server (not shown) can be configured to receive the area SA2. The search server can be configured to trigger a search primarily on the area I2′ corresponding with image I2. The search server can be configured to discard areas that should not be searched (e.g., the area between images I1 and I2). The search server can apply one or more criteria to determine that the area I2′ should be searched. The criteria can include, but is not limited to, an area of image I2 being greater than an area of image I1, the search results of image I2 being more robust (or complete) than the search results of image I1, and/or so forth. As a specific example, the search results of image I2 can be more robust (or complete) than the search results of image I1 if there are more search results associated with image I2 than image I1. As another specific example, the search results of image I2 can be more robust (or complete) than the search results of image I1 if there are more confident search results (e.g., search result hits have a higher confidence score) associated with image I2 than image I1.

In some implementations, multiple different search queries can be triggered in response to an area such as area SA2 that spans multiple areas of interest (e.g., multiple areas that could be independently searched). For example, a search server can be configured to conduct a first search query based on the portion of image I1 included in area SA2 and conduct a second search query based on the portion of image I2 included in area SA2.

This type of multiple search triggering can be useful when navigating, for example, a shopping website. If the webpage W1 is a shopping website, the images I1 and I2 can be associated with different products. Searches of the multiple products can be triggered with a single selection of area SA2.

In some implementations, search results from multiple searches that are triggered by a single area (e.g., area SA2) can be presented in various ways. In some implementations, search results from multiple searches that are triggered by a single area (e.g., area SA2) can be rendered in the search result area 130. Although not shown, in some implementations, the search results from multiple searches can be associated with different search result areas within the tab 112 of the browser 110. For example, search results from a first search can be associated with a first search result area and search results from a second search can be associated with a second search result area.

In some implementations, the search results from multiple searches can be associated with different tabs. For example, search results from a first search can be associated with a first tab and search results from a second search can be associated with a second tab.

In some implementations, the search results from multiple searches can be associated with different windows. For example, search results from a first search can be associated with (e.g., triggered to be rendered within and/or launch) a first browser window and search results from a second search can be associated with (e.g., triggered to be rendered within and/or launch) a second browser window. The search results associated with the first browser window and the search results associated within the second browser window can be rendered within search result areas within the respective first and second browser windows. One or more of the search result areas of the respective first and second browser windows can be persistent search result areas as described above in connection with at least FIGS. 1A through 5 (or in connection with any of the figures after FIG. 5).

In some implementations, the search results from multiple searches can be associated with different tabs within a single browser window. For example, search results from a first search can be associated with (e.g., triggered to be rendered within and/or launch) a first tab and search results from a second search can be associated with (e.g., triggered to be rendered within and/or launch) a second tab. The search results associated with the first tab and the search results associated within the second tab can be rendered within search result areas within the respective first and second tabs. One or more of the search result areas of the respective first and second tabs of the browser can be persistent search result areas as described above in connection with FIGS. 1A through 5.

In some implementations, the search results from multiple searches can be associated with (e.g., stored as) different bookmarks. For example, search results from a first search can be associated with a first bookmark (that can be later accessed) and search results from a second search can be associated with a second bookmark (that can be later accessed).

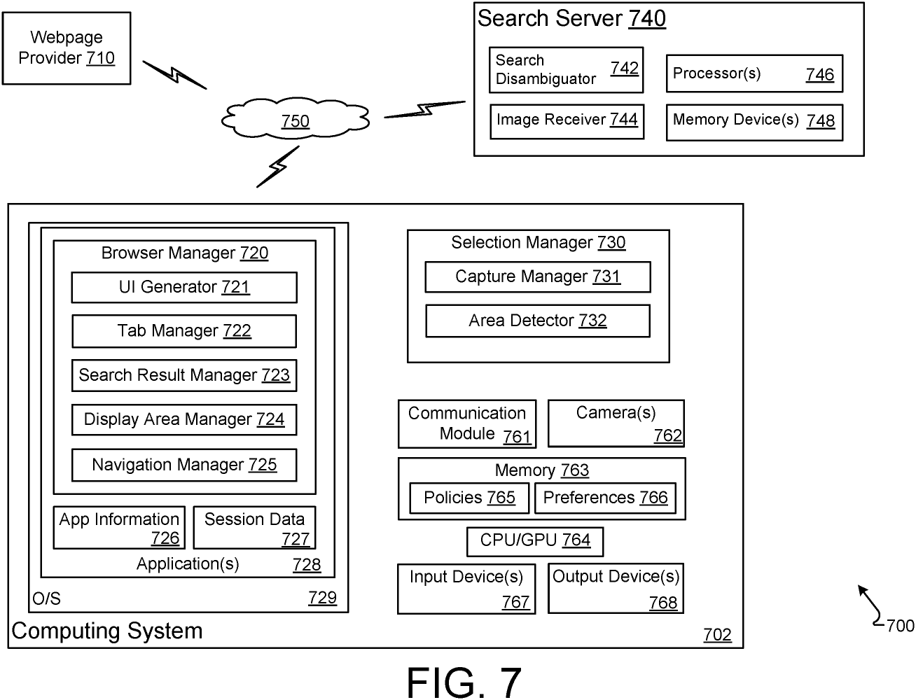

FIG. 7 illustrates a system 700 including a computing system 702 and a search server 740 configured for implementing the concepts and various implementations shown and described herein. As shown in FIG. 7, the computing system 702 is configured to communicate with the search server 740 and/or a webpage provider 710 (e.g., a web server) via a network 750. The computing system 702 includes at least a browser manager 720 and a selection manager 730. In some implementations, the browser manager 720 is configured to manage content, such as webpage content, provided by the webpage provider 710 (e.g., also can be referred to as a web server). In some implementations, the browser manager 720 is configured to operate as one of several application(s) 728 executed via an operating system (O/S) 729. The browser manager 720 can be configured to implement the key portions of the user interface, search results, windows, and/or so forth, as described in connection with the implementations described herein.

As shown in FIG. 7, the computing system 702 includes several hardware components including a communication module 761, one or more cameras 762, a memory 763, a central processing unit (CPU) and a graphics processing unit (GPU) 764, one or more input devices 767, and one or more output devices 768. The hardware components can be used to facilitate operation of the browser manager 720, the selection manager 730, and/or so forth of the computing system 702.

The browser manager 720 includes a user interface (UI) generator 721 configured to generate and/or manage the various user interface elements of a browser such as browser 110 as shown and described herein. For example, the UI generator 721 can generate UI elements including the various windows in the browser 110 such as the display area 120, the search result area 130, and/or the navigation area 140 shown in at least FIGS. 1A through 1C (and other figures).

The browser manager 720 includes a tab manager 722 configured to generate and/or manage the various tabs of a browser such as browser 110 as shown and described herein. For example, the tab manager 722 can generate the tabs in the browser 110 such as the tabs 112-1, 112-2 shown in at least FIG. 4A (and other figures).

The browser manager 720 includes a search result manager 723 configured to generate and/or manage content rendering such as search results S1 in the search result area 130 (shown in at least FIG. 1B and other figures). The browser manager 720 includes a display area manager 724 configured to generate and/or manage content rendering associated with a webpage W1 in the display areas 120, 125 (shown in FIG. 1B and other figures). The webpage W1 content can be provided to the computing system 702 by the webpage provider 710. The browser manager 720 includes a navigation manager 725 configured to generate and/or manage content rendering associated with the navigation areas 140 (shown in at least FIG. 1C and other figures).

As shown in FIG. 7, session data 727 (which can be stored in memory 763 (not shown)) can be managed as, or by, one of the applications 728. The session data 727 can include data related to one or more browser sessions. The application information 726 can include information related to the various applications operating within and/or that can be executed by the O/S 729.

The selection manager 730 can be configured to manage one or more elements selected for searching. The information from the selection manager 730 can be communicated to the search server 740 to trigger one or more search queries. The selection manager 730 includes an area detector 732 that can detect one or more areas (e.g., search area SA shown in FIG. 1B and other figures) selected for searching. The selection manager 730 also includes a capture manager 731 that can manage communication of content captured within one or more areas detected by the area detector 732. Selection of one or more areas for searching can be triggered by one or more input devices 767 (e.g., a mouse, a gesture, etc.) and can be communicated to the selection manager 730 (and area detector 732).

As shown in FIG. 7, the communication module 244 can be configured to facilitate communication with the webpage provider 710 and/or search server 740 via the network 750 via one or more communication protocols. The camera 762 can be used for capturing one or more images, the memory 763 can be used for storing information associated with the browser manager 720 and/or selection manager 730, the CPU/GPU 764 can be used for processing information and/or images associated with the browser manager 720 and/or selection manager 730. The computing system 702 also includes one or more output devices 768 such as communication ports, speakers, displays, and/or so forth. The functionality described in this application can be implemented based on one or more policies 765 and/or preferences 766 stored in the memory 763.

FIG. 7 illustrates some aspects of the search server 740. For example, the search server 740 includes one or more processors 746 and one or more memory devices 748. The search server 740 includes an image receiver 744 configured to receive one or more images from the computing system 702 that can be used to trigger a search query that can be executed at the search server 740. The one or more images can correspond with, for example, a search area (e.g., search area SA shown in at least FIG. 1A and in other figures). The search server 740 includes a search disambiguator 742 configured to determine a specific area to be searched when multiple areas (e.g., multiple images) that could be searched are sent to the search server 740. For example, the search disambiguator 742 can be used to resolve search queries covering multiple images such as the situation described in connection with FIGS. 6A and 6B. The search disambiguator 742 can be configured to implement the algorithms described in connection with FIGS. 6A and 6B.

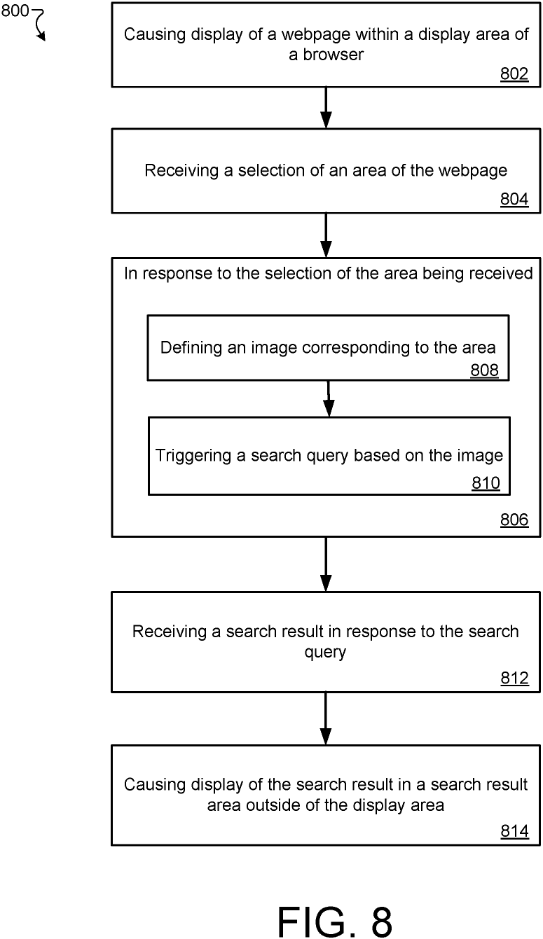

FIG. 8 is a flowchart that illustrates a method of performing at least some of the concepts described herein in the various figures. Many elements of the flowchart can be implemented by the components shown in at least FIG. 7.

The method includes causing display of a webpage within a display area of a browser (block 802). The webpage can be displayed as shown in, for example, the display area 120 of the browser 110 of FIG. 1A. The displaying of the webpage can be triggered by, for example, the display area manager 724 shown in FIG. 7.

The method includes receiving a selection of an area of the webpage (block 804). An example of selection of an area is shown as selection of search area SA of image I2 shown in FIG. 1B. The selection of the area of the webpage can be managed by the selection manager 730 shown in FIG. 7.

The method includes defining an image corresponding to the area (block 808) and triggering a search query based on the image (block 810), both in response to the selection of the area being received (block 806). For example, this process is depicted at least as an example in FIG. 1B. The search query can be triggered by the search area SA shown in FIG. 1B. The image corresponding to the area can be defined by the capture manager 731 of the selection manager 730 shown in FIG. 7. The image for searching can be sent by the selection manager 730 to the search server 740 shown in FIG. 7. The image receiver 744 can receive the image and the search query can be executed at the search server 740 shown in FIG. 7.

The method includes receiving a search result in response to the search query (block 812). For example, the search result S1 can be received by the browser 110 shown in FIG. 1A. The search result can be sent from the search server 740 to the computing system 702 via the network 750. Receipt and processing of the search results can be handled by the search result manager 723 of the browser manager 720.

The method includes causing display of the search result in a search result area outside of the display area, the search result area being within the browser (block 814). As shown in FIG. 1B, the search results S1 are rendered in the search result area 130. In some implementations, rendering of search results can be managed by the search result manager 723 of the browser manager 720. Further navigation, in a navigation area (e.g., navigation area 140 shown in, for example, FIG. 1C), of search results triggered by interaction with the search results can be managed by the navigation manager 725 of the browser manager 720 shown in FIG. 7.

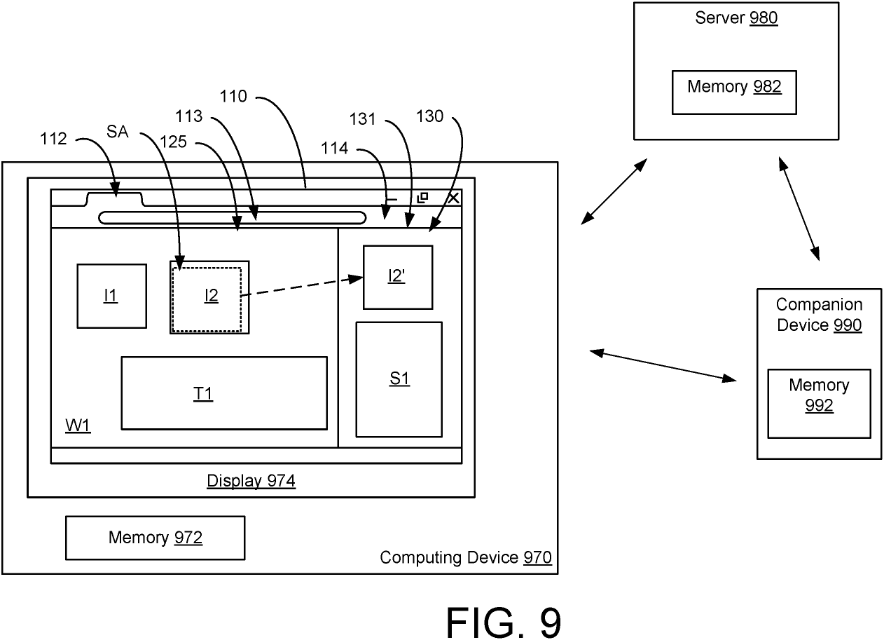

FIG. 9 illustrates an implementation where history related to search queries are shared between devices. The diagram in FIG. 9 is based on at least the implementation described in connection with FIGS. 1A through 1C. The implementation of FIG. 9 can be applied to any of the implementations described herein. The search history may be shared when permission has been granted by an owner of an account associated with the search history.

In this implementation, the browser 110 is displayed within a display 974 of a computing device 970. At least a portion of a search history related to the search area SA (or another search area) can be stored in a memory 972 of the computing device 970. In some implementations, the search history can be stored in response to a search query being triggered by the search area SA selection. In some implementations, the search history can be the search results S1 (or a representation of the search results S1) shown in FIG. 9 and in other figures such as FIG. 1A. At least a portion of search history can be shared with a server 980 (e.g., search server 740 shown in FIG. 7) and/or a companion device 990 based on permission granted via the computing device 970.

At least a portion of the search history can be shared with the server 980 from the computing device 970. At least a portion of the search history can be stored in a memory 982 of the server 980. In some implementations, the search history may be shared with the server 980 when the server 980 is associated with an account associated with the search history.

In some implementations, at least a portion of the search history may be shared with the companion device 990 by the computing device 970. In some implementations, the search history may be shared with the companion device 990 by the computing device 970 when permission has been granted by an owner of an account associated with the search history. In some implementations, the search history may be shared with the companion device 990 when the companion device 990 is associated with an account associated with the search history.

In some implementations, the server 980 can be configured to share at least a portion of the search history with the companion device 990. In some implementations, at least a portion of the search history may be shared with the companion device 990 by the server 980 when permission has been granted by an owner of an account associated with the search history. At least a portion of the search history received from the server 980 can be stored in a memory 992 of the companion device 990.

In some implementations, the companion device 990 can be configured to share at least a portion of the search history with the server 980. In some implementations, at least a portion of the search history may be shared with the server 980 by the companion device 990 when permission has been granted by an owner of an account associated with the search history. At least a portion of the search history received from the companion device 990 can be stored in the memory 982 of the server 980.

In some implementations, the search history can include a history of search queries. In some implementations, the search history can include a history of one or more objects (e.g., search area SA) that have been searched. In some implementations, the search history can include metadata identifying search queries and/or objects that have been searched.

In some implementations, search history can be shared between the computing device 970, server 980, and/or companion device 990 for purposes of collaboration. For example, the companion device 990 can use the search history to further refine a search query included in the search history. In some implementations, the refined search query can be shared with the computing device 970. As another example, the companion device 990 can use the search history to refine a search at the companion device 990 for use at the companion device 990.

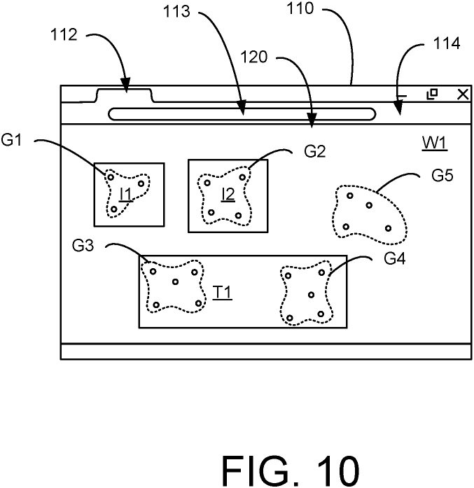

FIG. 10 is a diagram that illustrates indicators of areas that can be selected for a search query. An indicator of an area that can be searched can be referred to as a search area indicator. The search area indicators can be applied to any of the implementations described herein. The search area indicators can be produced and rendered for a user so that a user can be guided to and/or alerted to areas that can be selected to trigger a search query. In some implementations, the search area indicators can be rendered and/or managed by the display area manager 724.

The search area indicators, in this implementation, are illustrated as sets of circles overlayed over one or more portion of the webpage W1 and/or one or more portion of the objects I1, I2, T1 included in the webpage W1. The sets of circles are grouped as illustrated by the dashed lines of search area indicators G1 through G5. In some implementations, one or more of the search area indicators G1 through G5 can be different than shown in FIG. 10. One or more of the search area indicators G1 through G5 can be a different type of affordance, icon, and/or so forth.

In some implementations, the search area indicators G1 through G5 can be surfaced for areas that are high probability for searching. The probability of searching can be based on historical data related to the content on the webpage W1. The probability of searching can be based on historical data collected from many users (using anonymized data) who accessed the webpage W1 or a webpage similar to webpage W1.

In some implementations, the search area indicators G1 through G5 can be surfaced for areas that are not already linked within the webpage W1. For example, one or more of the search area indicators G1 through G5 can be associated with an image, text, and/or so forth embedded within the webpage W1. In some implementations, one or more of the search area indicators G1 through G5 can be associated with text that can be translated.

In some implementations, one or more of the search area indicators G1 through G5 can be surfaced based on an initial analysis of the webpage W1 without contacting a search server. For example, one or more of the search area indicators G1 through G5 can be defined in response to a local search performed on a computing device rendering the webpage W1.

In some implementations, one or more the search area indicators G1 through G5 can be associated with a shoppable object (e.g., an object associated with commerce). In some implementations, one or more the search area indicators G1 through G5 can be associated with an object that is publicly available.

In some implementations, search area indicators G1 through G5 can be illustrated in response to a webpage W1 being loaded. After at least one of search area indicators G1 through G5 is selected, the search area associated with the search area indicator can be searched. In other words, a search query can be triggered in response to the search area indicator being triggered (search query can be triggered as shown in, for example, FIG. 1B). As a specific example, the search area indicator G2 associated with image I2 can be selected (instead of selection of the search area SA as shown and described in FIG. 1A). The selection of the search area indicator G2 associated with image I2 can result in searching of at least a portion of the image I2 (e.g., search area SA) as shown in FIG. 1B.

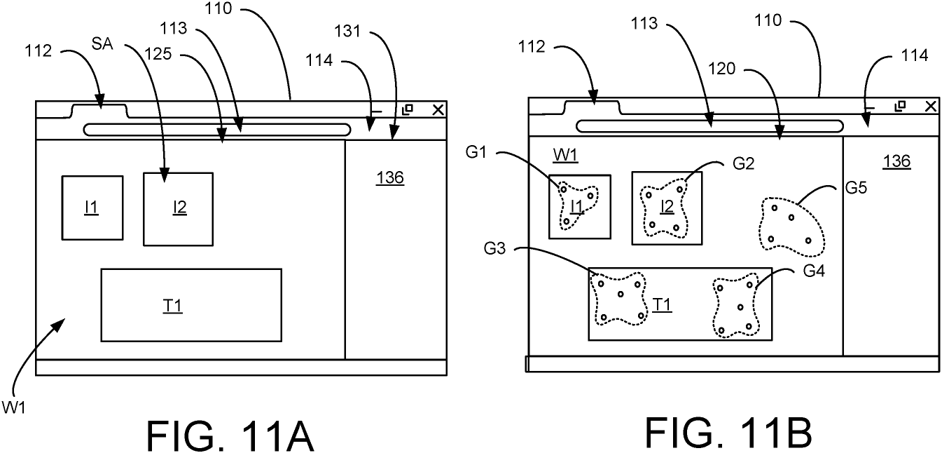

In some implementations, the search area indicators indicating areas that can be searched may be shown in response to a user interface for searching being activated. FIG. 11A illustrates activation of a search input area 136 (e.g., activated by a user) that can be used to define (e.g., trigger a search query). The search input area 136 can include a text and/or image input area (not shown) where a user can input, for example, text and/or images to trigger searching (e.g., one or more search queries) by a search server. In response to the search input area 136 being activated, search area indicators G1 through G5 are triggered (e.g., rendered) as shown in FIG. 11B.

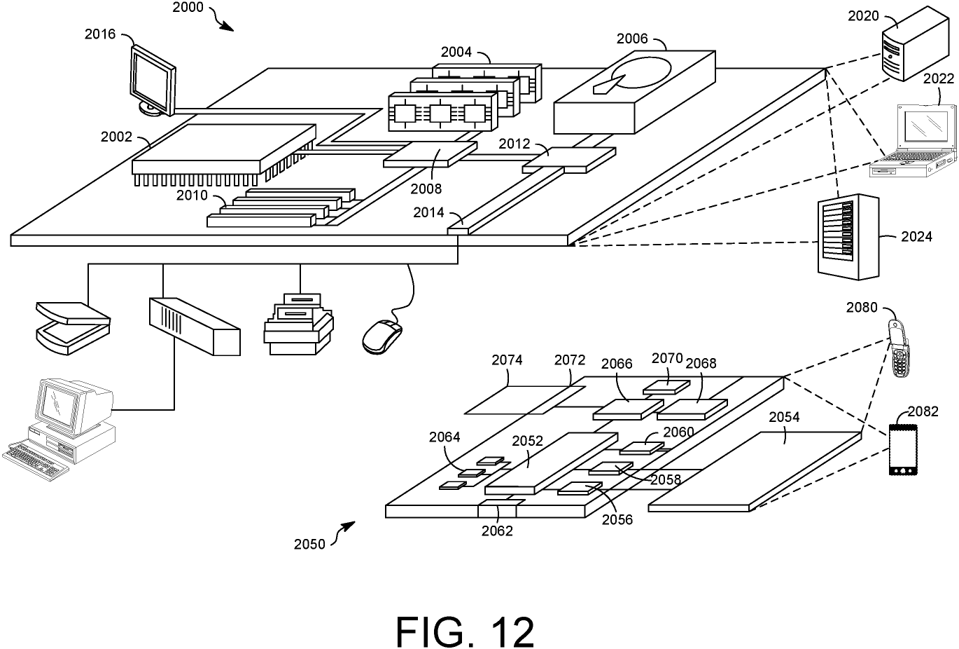

FIG. 12 shows an example of a generic computer device 2000 and a generic mobile computer device 2050, which may be used with the techniques described herein. Computing device 2000 is intended to represent various forms of digital computers, such as laptops, desktops, tablets, workstations, personal digital assistants, televisions, servers, blade servers, mainframes, and other appropriate computing devices. Computing device 2050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 2000 includes a processor 2002, memory 2004, a storage device 2006, a high-speed interface 2008 connecting to memory 2004 and high-speed expansion ports 2010, and a low speed interface 2012 connecting to low speed bus 2014 and storage device 2006. The processor 2002 can be a semiconductor-based processor. The memory 2004 can be a semiconductor-based memory. Each of the components 2002, 2004, 2006, 2008, 2010, and 2012, are interconnected using various busses, and may be mounted on a common motherboard or in other manners as appropriate. The processor 2002 can process instructions for execution within the computing device 2000, including instructions stored in the memory 2004 or on the storage device 2006 to display graphical information for a GUI on an external input/output device, such as display 2016 coupled to high speed interface 2008. In other implementations, multiple processors and/or multiple buses may be used, as appropriate, along with multiple memories and types of memory. Also, multiple computing devices 2000 may be connected, with each device providing portions of the necessary operations (e.g., as a server bank, a group of blade servers, or a multi-processor system).

The memory 2004 stores information within the computing device 2000. In one implementation, the memory 2004 is a volatile memory unit or units. In another implementation, the memory 2004 is a non-volatile memory unit or units. The memory 2004 may also be another form of computer-readable medium, such as a magnetic or optical disk.

The storage device 2006 is capable of providing mass storage for the computing device 2000. In one implementation, the storage device 2006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 2004, the storage device 2006, or memory on processor 2002.

The high speed controller 2008 manages bandwidth-intensive operations for the computing device 2000, while the low speed controller 2012 manages lower bandwidth-intensive operations. Such allocation of functions is exemplary only. In one implementation, the high-speed controller 2008 is coupled to memory 2004, display 2016 (e.g., through a graphics processor or accelerator), and to high-speed expansion ports 2010, which may accept various expansion cards (not shown). In the implementation, low-speed controller 2012 is coupled to storage device 2006 and low-speed expansion port 2014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 2000 may be implemented in a number of different forms, as shown in the figure. For example, it may be implemented as a standard server 2020, or multiple times in a group of such servers. It may also be implemented as part of a rack server system 2024. In addition, it may be implemented in a personal computer such as a laptop computer 2022. Alternatively, components from computing device 2000 may be combined with other components in a mobile device (not shown), such as device 2050. Each of such devices may contain one or more of computing device 2000, 2050, and an entire system may be made up of multiple computing devices 2000, 2050 communicating with each other.

Computing device 2050 includes a processor 2052, memory 2064, an input/output device such as a display 2054, a communication interface 2066, and a transceiver 2068, among other components. The device 2050 may also be provided with a storage device, such as a microdrive or other device, to provide additional storage. Each of the components 2050, 2052, 2064, 2054, 2066, and 2068, are interconnected using various buses, and several of the components may be mounted on a common motherboard or in other manners as appropriate.

The processor 2052 can execute instructions within the computing device 2050, including instructions stored in the memory 2064. The processor may be implemented as a chipset of chips that include separate and multiple analog and digital processors. The processor may provide, for example, for coordination of the other components of the device 2050, such as control of user interfaces, applications run by device 2050, and wireless communication by device 2050.

Processor 2052 may communicate with a user through control interface 2058 and display interface 2056 coupled to a display 2054. The display 2054 may be, for example, a TFT LCD (Thin-Film-Transistor Liquid Crystal Display) or an OLED (Organic Light Emitting Diode) display, or other appropriate display technology. The display interface 2056 may comprise appropriate circuitry for driving the display 2054 to present graphical and other information to a user. The control interface 2058 may receive commands from a user and convert them for submission to the processor 2052. In addition, an external interface 2062 may be provide in communication with processor 2052, so as to enable near area communication of device 2050 with other devices. External interface 2062 may provide, for example, for wired communication in some implementations, or for wireless communication in other implementations, and multiple interfaces may also be used.

The memory 2064 stores information within the computing device 2050. The memory 2064 can be implemented as one or more of a computer-readable medium or media, a volatile memory unit or units, or a non-volatile memory unit or units. Expansion memory 2074 may also be provided and connected to device 2050 through expansion interface 2072, which may include, for example, a SIMM (Single In Line Memory Module) card interface. Such expansion memory 2074 may provide extra storage space for device 2050, or may also store applications or other information for device 2050. Specifically, expansion memory 2074 may include instructions to carry out or supplement the processes described above, and may include secure information also. Thus, for example, expansion memory 2074 may be provide as a security module for device 2050, and may be programmed with instructions that permit secure use of device 2050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 2064, expansion memory 2074, or memory on processor 2052, that may be received, for example, over transceiver 2068 or external interface 2062.

Device 2050 may communicate wirelessly through communication interface 2066, which may include digital signal processing circuitry where necessary. Communication interface 2066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 2068. In addition, short-range communication may occur, such as using a Bluetooth, WiFi, or other such transceiver (not shown). In addition, GPS (Global Positioning System) receiver module 2070 may provide additional navigation- and location-related wireless data to device 2050, which may be used as appropriate by applications running on device 2050.

Device 2050 may also communicate audibly using audio codec 2060, which may receive spoken information from a user and convert it to usable digital information. Audio codec 2060 may likewise generate audible sound for a user, such as through a speaker, e.g., in a handset of device 2050. Such sound may include sound from voice telephone calls, may include recorded sound (e.g., voice messages, music files, etc.) and may also include sound generated by applications operating on device 2050.

The computing device 2050 may be implemented in a number of different forms, as shown in the figure. For example, it may be implemented as a cellular telephone 2080. It may also be implemented as part of a smart phone 2082, personal digital assistant, or other similar mobile device.

In the following some examples are described.
Example 1: A method, comprising:
   causing display of a webpage within a display area of a browser;
   receiving a selection of an area of the webpage;
   in response to the selection of the area being received:
      defining an image corresponding to the area, and
      triggering a search query based on the image;
   receiving a search result in response to the search query; and
   causing display of the search result in a search result area outside of the display area, the search result area being within the browser.
Example 2: The method of example 1, further comprising:
   receiving an indication of an interaction with the search result; and
   replacing the display area with a navigation area where content associated with the search result is displayed in response to an interaction with the search result area.
Example 3: The method of example 1 or 2, further comprising:
   receiving an indication of an interaction with the search result; and
   replacing the webpage in the display area with content associated with the search result.
Example 4: The method of any one of examples 1 to 3, wherein the display area is within a first tab of the browser,
   the method further comprising:
   receiving an indication of an interaction with the search result; and
   triggering display of content associated with the search result in a second tab of the browser.
Example 5: The method of any one of the preceding examples, wherein the browser corresponds with a first browser window,
   the method further comprising:
   receiving an indication of an interaction with the search result; and
   triggering display of content associated with the search result in a second browser window separate from the first browser window.
Example 6: The method of any one of the preceding examples, wherein the display area is resized such that the search result area is disposed within an area allocated, prior to the receiving the selection of the area of the webpage, to the display area.
Example 7: The method of any one of the preceding examples, wherein the image is a screen capture of the area.
Example 8: The method of any one of preceding examples, wherein the search result area is within a tab of the browser.
Example 9: The method of examples 4 and 8, wherein the search result area is within the first tab.
Example 10: The method of any one of the preceding examples, wherein the webpage includes a plurality of images displayed within the webpage, the area includes at least a portion of each of at least two images from the plurality of images.
Example 11: The method of any one of the preceding examples, wherein the display area is decreased in size in response to the search result area being displayed.
Example 12: The method of any one of the preceding examples, wherein the image is a first image, the area includes at least a portion of a second image rendered within the webpage.
Example 13: A method, comprising:
   causing display of a webpage within a display area of a browser;
   causing display of a search area indicator associated with an area of the webpage;
   receiving a selection of the search area indicator;
   in response to the selection of the search area indicator being received:
      defining an image corresponding to the area, and
      triggering a search query based on the image;
   receiving a search result in response to the search query; and
   causing display of the search result in a search result area outside of the display area, the search result area being within the browser.
Example 14: The method of example 13, further comprising:
   activating a search input area, the display of the search area indicator being caused in response to the search input area being activated.
Example 15: The method of example 14, wherein the search input area corresponds with the search result area.
Example 16: The method of example 14 or 15, wherein the search input area is activated in response to a user interaction.
Example 17: A system, comprising:
   a processor; and
   a memory device communicatively coupled to the processor and having stored therein a plurality of instructions, which when executed by the processor, cause the processor to:
      cause display of a webpage within a display area of a browser;
      receive a selection of an area of the webpage;
      in response to the selection of the area being received:
         define an image corresponding to the area, and
         trigger a search query based on the image;
      receive a search result in response to the search query; and
      cause display of the search result in a search result area outside of the display area, the search result area being within the browser.
Example 18: The system of example 17, wherein the memory device further stores instructions, which when executed by the processor, cause the processor to:
   receive an indication of an interaction with the search result; and
   replace the display area with a navigation area where content associated with the search result is displayed in response to an interaction with the search result area.
Example 19: The system of example 17, wherein the memory device further stores instructions, which when executed by the processor, cause the processor to:
   receive an indication of an interaction with the search result; and
   replace the webpage in the display area with content associated with the search result.
Example 20: The system of any one of examples 17 to 19, wherein the display area is within a first tab of the browser,
   the memory device further stores instructions, which when executed by the processor, cause the processor to:
      receive an indication of an interaction with the search result; and
      trigger display of content associated with the search result in a second tab of the browser.
Example 21: A machine-readable, tangible medium storing instructions, which may be read and executed by one or more processors to perform a method, the method comprising:
   causing display of a webpage within a display area of a browser;
   receiving a selection of an area of the webpage;
   in response to the selection of the area being received:
      defining an image corresponding to the area, and
      triggering a search query based on the image;
   receiving a search result in response to the search query; and
   causing display of the search result in a search result area outside of the display area, the search result area being within the browser.
Example 22: The machine-readable, tangible medium of example 21, further comprising:
   receiving an indication of an interaction with the search result; and
   replacing the display area with a navigation area where content associated with the search result is displayed in response to an interaction with the search result area.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

What is claimed is:

1. A method, comprising:
causing display of a webpage within a display area of a browser;
receiving a selection of an area of the webpage;
in response to the selection of the area being received:
defining an image corresponding to the area, and
triggering a search query based on the image;
receiving a search result in response to the search query; and
causing display of the search result in a search result area outside of the display area, the search result area being within the browser.

2. The method of claim 1, further comprising:
receiving an indication of an interaction with the search result; and
replacing the display area with a navigation area where content associated with the search result is displayed in response to the interaction with the search result.

3. The method of claim 1, further comprising:
receiving an indication of an interaction with the search result; and
replacing the webpage in the display area with content associated with the search result.

4. The method of claim 1, wherein the display area is within a first tab of the browser,
the method further comprising:
receiving an indication of an interaction with the search result; and
triggering display of content associated with the search result in a second tab of the browser.

5. The method of claim 1, wherein the browser corresponds with a first browser window,
the method further comprising:
receiving an indication of an interaction with the search result; and
triggering display of content associated with the search result in a second browser window separate from the first browser window.

6. The method of claim 1, wherein the display area is resized such that the search result area is disposed within an area allocated, prior to the receiving the selection of the area of the webpage, to the display area.

7. The method of claim 1, wherein the image is a screen capture of the area.

8. The method of claim 1, wherein the search result area is within a tab of the browser.

9. The method of claim 1, wherein the webpage includes a plurality of images displayed within the webpage, the area includes at least a portion of each of at least two images from the plurality of images.

10. The method of claim 1, wherein the display area is decreased in size in response to the search result area being displayed.

11. The method of claim 1, wherein the image is a first image, the area includes at least a portion of a second image rendered within the webpage.

12. A method, comprising:
causing display of a webpage within a display area of a browser;
causing display of a search area indicator associated with an area of the webpage;
receiving a selection of the search area indicator;
in response to the selection of the search area indicator being received:
defining an image corresponding to the area, and
triggering a search query based on the image;
receiving a search result in response to the search query; and
causing display of the search result in a search result area outside of the display area, the search result area being within the browser.

13. The method of claim 12, further comprising:
activating a search input area, the display of the search area indicator being caused in response to the search input area being activated.

14. The method of claim 13, wherein the search input area corresponds with the search result area.

15. The method of claim 13, wherein the search input area is activated in response to a user interaction.

16. A system, comprising:
a processor; and
a memory device communicatively coupled to the processor and having stored therein a plurality of instructions, which when executed by the processor, cause the processor to:
cause display of a webpage within a display area of a browser;
receive a selection of an area of the webpage;
in response to the selection of the area being received:
define an image corresponding to the area, and
trigger a search query based on the image;
receive a search result in response to the search query; and
cause display of the search result in a search result area outside of the display area, the search result area being within the browser.

17. The system of claim 16, wherein the memory device further stores instructions, which when executed by the processor, cause the processor to:
receive an indication of an interaction with the search result; and
replace the display area with a navigation area where content associated with the search result is displayed in response to an interaction with the search result area.

18. The system of claim 16, wherein the memory device further stores instructions, which when executed by the processor, cause the processor to:
receive an indication of an interaction with the search result; and
replace the webpage in the display area with content associated with the search result.

19. The system of claim 16, wherein the display area is within a first tab of the browser,
the memory device further stores instructions, which when executed by the processor, cause the processor to:
receive an indication of an interaction with the search result; and
trigger display of content associated with the search result in a second tab of the browser.

20. A machine-readable, tangible medium storing instructions, which may be read and executed by one or more processors to perform a method, the method comprising:
causing display of a webpage within a display area of a browser;
receiving a selection of an area of the webpage;
in response to the selection of the area being received:
defining an image corresponding to the area, and
triggering a search query based on the image;
receiving a search result in response to the search query; and
causing display of the search result in a search result area outside of the display area, the search result area being within the browser.

21. The machine-readable, tangible medium of claim 20, further comprising:
receiving an indication of an interaction with the search result; and
replacing the display area with a navigation area where content associated with the search result is displayed in response to an interaction with the search result area.

22. A method, comprising:
causing display of a webpage within a display area of a first browser window;
receiving a selection of an area of the webpage;
in response to the selection of the area being received:
defining an image corresponding to the area, and
triggering a search query based on the image;
receiving a search result in response to the search query; and
causing display of the search result in a search result area outside of the display area and within a second browser window.

23. The method of claim 22, further comprising:
receiving an indication of an interaction with the search result; and
replacing the display area with a navigation area in the first browser window where content associated with the search result is displayed in response to the interaction with the search result in the second browser window.
